(19) United States
(12) Patent Application Publication
(10) Pub. No.: US 2026/0361111 A1
(43) Pub. Date: Nov. 12, 2026

(54) ELECTROMECHANICAL LOCK AND METHOD OF POWERING ELECTROMECHANICAL LOCK

(71) Applicant: iLOQ Oy, Oulu (FI)

(72) Inventors: Väinö TIKKANEN, Oulu (FI); Aki PIHLAJAMAA, Oulu (FI)

(21) Appl. No.: 19/129,512

(22) PCT Filed: Dec. 20, 2024
(86) PCT No.: PCT/EP2024/088144

§ 371 Date: May 13, 2025

(30) Foreign Application Priority Data
Dec. 21, 2023 (EP) 23219276.5

(51) Int. Cl. H02J 7/00; E05B 47/00; H02J 7/34

(52) U.S. Cl. CPC H02J 7/865; E05B 47/0001; E05B 2047/0062; E05B 2047/0097; H02J 7/345; H02J 2207/50

(57) ABSTRACT

An electromechanical lock comprises a data processing unit, at least two capacitors, an electric switch arrangement and an electric energy receiver. The electric switch arrangement, for enabling repeated charging and discharging of the at least two capacitors performs the following. Couples the at least two capacitors in parallel for charging the at least two capacitors with electric energy of the electric energy receiver. Couples the at least two capacitors, which are charged with electric energy, in series. Couple the at least two capacitors in series with the data processing unit, the at least two capacitors in series discharging electric energy for electric operation of the electromechanical lock.

### FIELD

The invention relates to an electromechanical lock and a method of powering the electromechanical lock.

### BACKGROUND

Various types of electromechanical locking systems are replacing traditional mechanical locking systems and wired access control systems. Wireless electromechanical locks may not need electric power sources such as batteries for their operation. Instead they may generate electric power within the lock or receive the required electric power from an electric device of the user. The electro-mechanical lock may thus be user-powered or externally wirelessly powered. Electro-mechanical locking systems provide a user with good security, flexible access management of keys and they are easy to install, for example. However, further refinement is needed for making the electromechanical locks operate more effectively with the electric energy they have for their operation.

### BRIEF DESCRIPTION

The present invention seeks to provide an improvement in the measurements.

The invention is defined by the independent claims. Embodiments are defined in the dependent claims.

If one or more of the embodiments is considered not to fall under the scope of the independent claims, such an embodiment is or such embodiments are still useful for understanding features of the invention.

### LIST OF DRAWINGS

Example embodiments of the present invention are described below, by way of example only, with reference to the accompanying drawings, in which

FIG. 1A illustrates an example of an electromechanical lock with a mechanical key;

FIG. 1B illustrates an example of an electromechanical lock with a knob or handle for providing energy for operation of the electromechanical lock;

FIG. 2 illustrates an example of feeding electric energy wirelessly to the electromechanical lock;

FIG. 3 illustrates an example of an electric circuitry of the electromechanical lock;

FIG. 4A illustrates an example of a switch arrangement and states of switches between an electric energy receiver and a data processing unit for charging capacitors;

FIG. 4B illustrates an example of a switch arrangement and states of switches between an electric energy receiver and a data processing unit for discharging capacitors;

FIG. 5A illustrates an example of voltage behaviour of capacitors during discharging while coupling of capacitors is swapped;

FIG. 5B illustrates an example of voltage behaviour of capacitors during discharging while coupling of more and more capacitors are swapped one by one;

FIG. 6A illustrates an example of a plurality of capacitors in parallel coupling for charging;

FIG. 6B illustrates an example of a plurality of capacitors coupled such that a parallel coupling of capacitors is in series with one capacitor for in a discharging phase;

FIG. 6C illustrates an example of a plurality of capacitors coupled in series;

FIG. 7 illustrates an example of a data processing unit; and

FIG. 8 illustrates an example of a flow chart of a method of powering an electromechanical lock.

### DESCRIPTION OF EMBODIMENTS

The following embodiments are only examples. Although the specification may refer to “an” embodiment in several locations, this does not necessarily mean that each such reference is to the same embodiment(s), or that the feature only applies to a single embodiment.

Single features of different embodiments may also be combined to provide other embodiments. Furthermore, words “comprising” and “including” should be understood as not limiting the described embodiments to consist of only those features that have been mentioned and such embodiments may also contain features/structures that have not been specifically mentioned. All combinations of the embodiments are considered possible if their combination does not lead to structural or logical contradiction. Single features of different embodiments may also be combined to provide other embodiments.

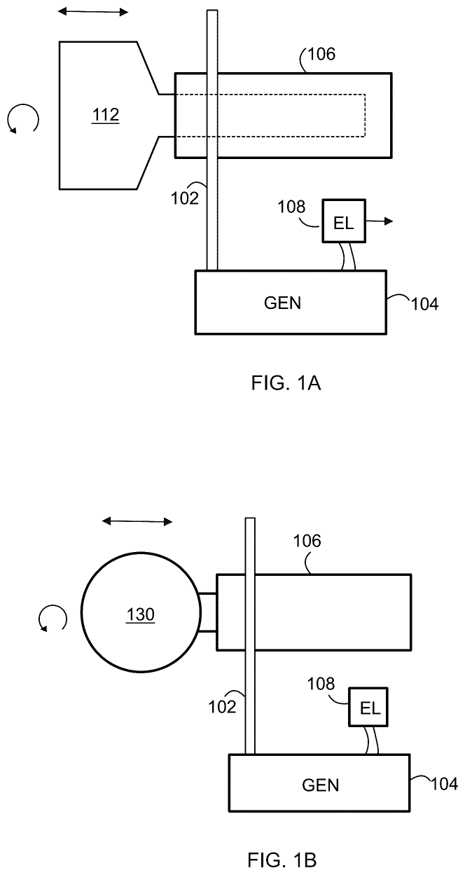

Electric energy for full or partial operation of the electromechanical lock can be received in various manners. In an embodiment examples of which is illustrated in FIGS. 1A and 1B, mechanical work of a user can be transformed into electrical energy. That is, kinetic energy of a turn of a knob or handle of a door, or a turn or linear movement of a key of the electromechanical lock can be transformed by an electric generator into electric energy for the electromechanical lock. The electric generator converts energy of motion into electric energy. Instead of referring to energy, the word power may be used in general, i.e. power of motion is converted into electric power, for example. Power refers to energy per time unit. Additionally or alternatively, electric energy may be provided by light cell, a vibration harvester, temperature harvester, piezo element(s), for example, without limiting to these.

FIG. 1A illustrates an example of an electromechanical lock with an electro mechanical key 112. A transmission mechanism 102 may convey the kinetic energy to a generator 104 while the user is turning a key 112 in the electromechanical lock. Alternatively or additionally, kinetic energy of the linear movement of the key 112 into and/or inside the main shaft 106 may be received by the transmission mechanism 102 that conveys the kinetic energy to the electric generator 104. The kinetic energy may alternatively be called motion energy. The electric generator 104, in turn, converts the kinetic energy into electric energy. The electric generator 104 then feeds the electric energy to an electric circuit 108 of the electromechanics lock. The electric circuit 108 participates the electric operation of the electromechanical lock. A person skilled in the art is familiar with the electromechanic operation of the electromechanical lock, per se.

In FIG. 1B, the transmission mechanism 102 conveys the kinetic energy of a turning handle or knob 130 that the user is turning, pushing and/or bending to the electric generator 104. Apart from the handle or knob 130, other suitable turning mechanisms may additionally or alternatively be used for receiving motion energy from the work of the user. In a similar manner to the example of FIG. 1A, the electric generator 104 converts the kinetic energy into electric energy.

In examples of FIGS. 1A and 1B, the electric generator 104 may be a permanent magnet generator, for example. The output power of the generator 104 depends on rotating speed, terminal resistance and terminal voltage of the electronic and the constants of the electric generator 104.

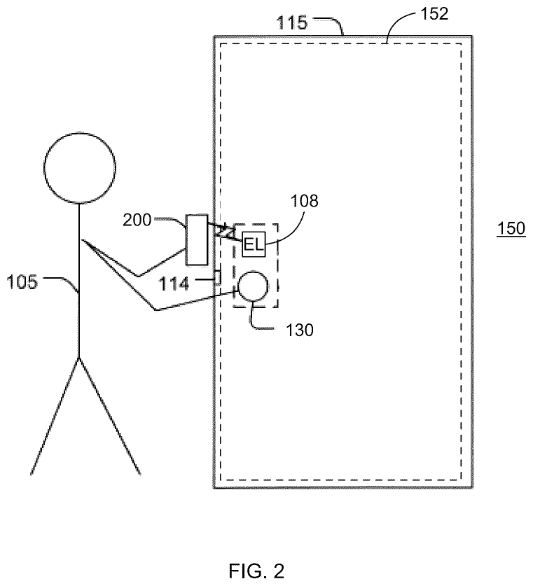

FIG. 2 illustrates an embodiment of an electronic locking system. The key 112 may be an electronic key for wirelessly opening the electromechanical lock that is wireless and batteryless. The key 112 may be carried by a person as a part of his wireless communication device 200, for example. That means, the key 112 may be an application program in the wireless communication device 200, for example. Alternatively, the key 112 may be a separate wireless electronic communication device that is configured to transmit electromagnetic radiation to the electric circuit 108 of the electromechanical lock. The electromagnetic radiation may carry deterministic digital information.

The communication device 200 refers to a portable electric device. The device may be a computing device and/or a communication device. Such electric devices include devices such as a mobile phone, a smartphone, a tablet computer, a personal digital assistant (PDA), a personal computer or merely a portable key that can communicate wirelessly with the electromechanical lock. The communication device 200 may have a wireless network channel connection to a wireless network such as the Internet. The wireless connection channel 202 and the wireless network 204 may be implemented according to the GSM (Global System for Mobile Communications), WCDMA (Wideband Code Division Multiple Access), WLAN (Wireless Local Area Network) or any other suitable standard/non-standard wireless communication means.

The communication device 200 is equipped with a short-range wireless communication unit configured to communicate with other respective short-range units upon detecting such a unit. In an embodiment, short-range wireless communication is realised with a Near Field Communication (NFC) technique. NFC is a set of short-range wireless technologies, typically requiring a distance of about 4 cm or less. NFC may operate at 13.56 MHz on ISO/IEC 18000-3 air interface and at rates ranging from about 106 kbit/s to 424 kbit/s. NFC always involves an initiator and a target; the initiator actively generates a radio frequency (RF) signal that can power a passive target. This enables NFC targets to take very simple form factors such as tags, stickers, key fobs, or cards that do not require batteries. Above, ISO stands for International Organization for Standardization and IEC for the International Electrotechnical Commission.

In FIG. 2, a user 105 is at a barrier structure 115 that is configured to cover fully or partially a hole 152 of a wall 150. The wall 150 may have a frame fully or partially round the hole (frame is not illustrated in FIG. 2). The barrier structure 115 is of solid and hard material and may be made of one or more solid and hard materials. The barrier structure 115 is movable or turnable for opening and/or closing the hole 152 of the wall 150, the hole 152 serving as an entrance from one side of barrier structure 115 to the other side. The barrier structure 115 may swing on one or more hinges or slide along a rail or grove, for example. The barrier structure 115 can usually be repeatedly opened and closed. The barrier structure 115 may be a door, gate or window, for example. The barrier structure 115 may be locked with the wall 150 in a closed position by the electromechanical lock such that the barrier structure 115 is immobile fully or partially, and in the locked position an entrance from one side to the other side of the barrier structure 115 is fully blocked. The partial mobility of the barrier structure 115, the partial mobility being potential and/or optional, may relate to allowable tolerance, for example. When the electromechanical lock is opened, also the barrier structure 115 may be opened for passing through the hole 152 of the wall 150. In FIG. 2, a bolt 114 of the electromechanical lock is an example how to immobilize i.e. lock the barrier structure 115 with the wall 150. A person skilled in the art is familiar with immobilization and/or locking the barrier structure 115 with the wall 150, per se.

In a passive communication mode of the communication device 200 provides a suitable electromagnetic field, and the electronic circuit 108 of the electromagnetic lock responds to the electromagnetic field. In this mode, the lock may draw its operating power from the electromagnetic field generated by the communication device 200, thus making the lock a transponder.

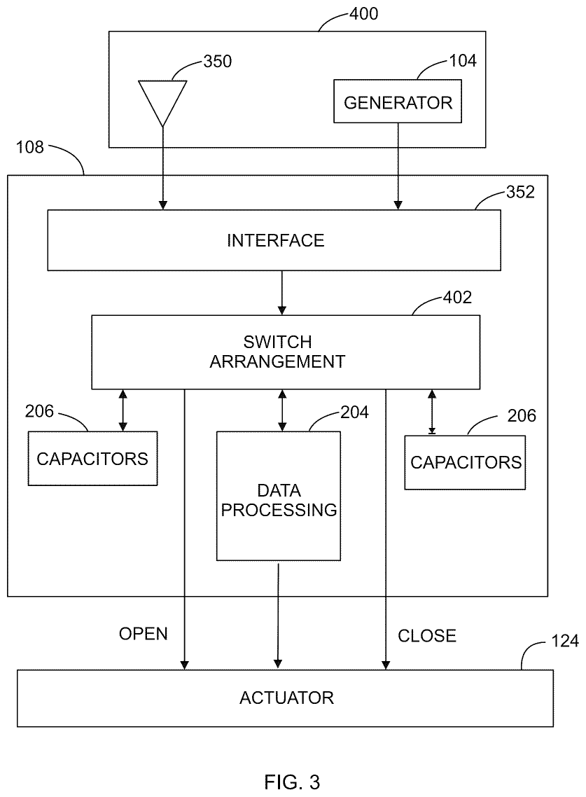

FIG. 3 illustrated an example of the electric circuit 108 of the electromechanical lock. The energy receiver 400, which may be the electric generator 104 or a RF (radio frequency) antenna 350, feed electric energy to an interface 352, which may comprise an RF interface for the RF antenna 350. The electric circuit 108 comprises a data processing unit or a microcontroller 204, a switch arrangement 402, at least two capacitors 206 and an actuator 124. The microprocessor 204 receives energy for its operation from the radio frequency signal received by the RF antenna 350. The interface 352 that comprises the RF interface may convert the RF signals received from the antenna 350 into DC (direct current) electric signals for charging the capacitors 206. The interface 352 may convert the electric energy from the electric generator 104 into DC signals for changing the capacitors 206.

In an embodiment, the interface 352 that comprises the RF interface may comprise an NFC transceiver. The processing unit 204 may be a microcontroller, a processor or an electric circuitry comprising a memory for storing a computer program of instructions.

The processing unit 204 is configured to process authentication procedure in connection with the communication device 200 or electromechanical key 112. After a successful authentication and when sufficient electric energy level is obtained, the processing unit 204 may start operating and control the actuator 124 to set the lock in a mechanically openable state. Then the capacitors 206 couple electric energy to the actuator 124 for performing the opening operation of the electromechanical lock. After a predefined delay the actuator 124 is reset back to the locked state. In an embodiment, the actuator 124 may comprise an electric motor which is driven in one direction in the openable state and in an opposite direction for reset, for example. When the actuator 124 has set the electromechanical lock in a mechanically openable state, the locking mechanism 114 can be moved by operating the user interface such as the key, knob and/or handle 112, 130, for example. Other suitable operating mechanisms may be used as well.

In an embodiment, the delay after which the electric switch arrangement 402 couples the at least two capacitors 206, 206(1), 206(2) in series may be programmable. Then the data processing unit may cause the change of coupling of the capacitors 206, 206(1), 206(2) as programmed in the memory. The delay may thus be adjustable in a programmable manner. Alternatively or additionally, the delay may be based on a measurement of voltage over the capacitors 206, 206(1), 206(2).

The at least two capacitors 206 are configured to store electric energy and they are also configured to discharge the electric energy for a desired purpose in a controlled manner. That is, they are repeatedly chargeable and dischargeable. The number of the capacitors 206 is not limited, and the number of capacitors 206 may be a design feature.

The electronic circuitry 108 including the processing unit 204 is configured to operate on the power received wirelessly from the communication device 106 or from the electric generator 104. In addition, the capacitors 206 of the electronic circuitry 108 may be configured to receive and store operating power for the actuator means.

Energy E of capacitors 206 is E=Q²/2C, where Q is the electric charge stored in the capacitors 206 and C is a total capacitance of the capacitors 206. As a result, the total work at maximum that is attainable is also E. In reality, the operational voltage of the data processing unit 204 limits the usable energy. Namely, the voltage over the capacitors 206 decreases with decreasing charge stored in the capacitors 206. When the voltage over the capacitors 206 has decreased at or below the minimum operational voltage of the data processing unit 204, the electric energy remaining in the capacitors 206 cannot be utilized but it is wasted if the coupling of the capacitors 206 is not modified. The similar reason may apply to use of the electric energy for the actuator 124, too. The minimum operational voltage of the data processing unit 204 may be about 3 V, for example. Assuming the capacitors 206 have the voltage of about 6 V with a maximum charge, for example, the energy stored by the capacitors 206 may largely be unusable because the voltage range between 0V to about 3V cannot be utilized. Because the maximum chargeable voltage and the minimum operational voltage cover a large percentage of the whole voltage range, changing the coupling of the capacitors 206, 206(1), 206(2) is technically effective and brings a technical advantage. The following example casts light to this. Assume two capacitors, each 50 μF, and assume that they can be charged such that a voltage over a parallel coupling of them is 3V. The voltage level may be limited by the NFC (Near Field Communication). Assume also that the voltage range of the processor is 2V to 5V and the discharge current is 5 μA. These assumptions lead to about 20 s of operation for the processor. However, assuming that the capacitors are swapped to the series coupling and the maximum voltage level over the capacitors is raised to 4V because of the swap, the data processing unit can operate about 30 s within the decreasing voltage in the range 4V to 2V. That means 50% increase in the operational time. The technical feature may, of course, be utilized also alternatively. The alternative uses may, for example, be shortening the charging time, and/or making the receiving antenna and/or the electric energy generator smaller while keeping the operational time unchanged in 20 s.

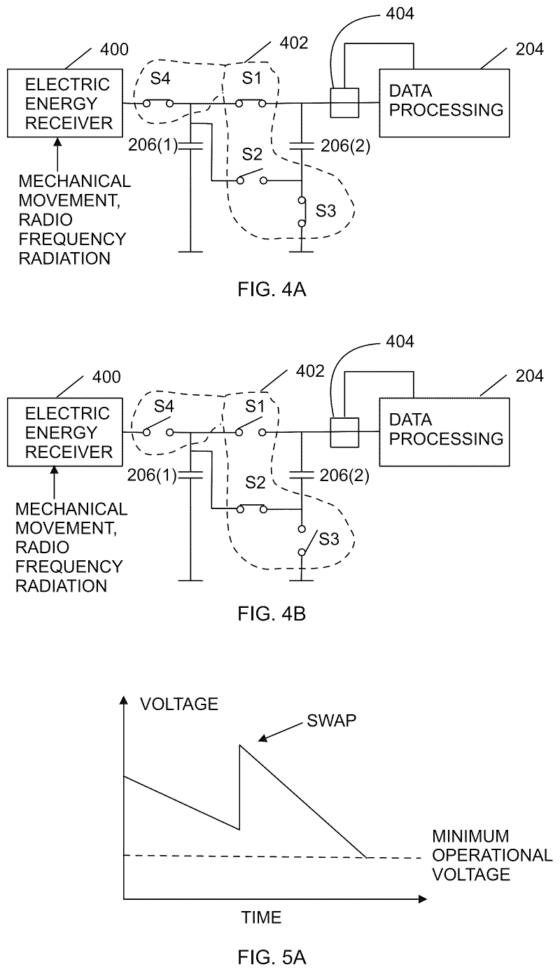

FIGS. 4A and 4B illustrate an example of how to utilize more efficiently the electric energy stored by the capacitors 206. The electromechanical lock comprises the data processing unit 204, the at least two capacitors 206, the electric switch arrangement 402 that includes switches S1, S2, S3 and the electric energy receiver 400. The electric switch arrangement 402 may also comprise switch S4 but its use may be optional in general. For enabling repeated charging and discharging of the at least two capacitors 206, the electric switch arrangement 402 connects the at least two capacitors 206(1), 206(2) in an operational connection with the electric energy receiver 400, and connects the at least two capacitors 206(1), 206(2) in parallel for charging the at least two capacitors 206(1), 206(2) with electric energy of the electric energy receiver 400.

Additionally, the electric switch arrangement 402 connects the at least two capacitors 206(1), 206(2) charged with electric energy with the data processing unit 204. The at least two capacitors 206(1), 206(2) then discharge electric energy for electric operation of the electromechanical lock. The discharged electric energy may be fed to the data processing unit 204, for example.

The data processing unit 204 is coupled with a first pin of a capacitor 206(2). A second pin of the capacitor 206(2) is connectable with ground through the switch S3. The data processing unit 204 is also couplable with a first pin of the capacitor 206(1) through a switch S1. The second pin of the capacitor 206(1) is coupled with ground. The first pin of the capacitor 206(1) is also coupled with the electric energy receiver 400. The connection between the first pin of the capacitor 206 (1) and the electric energy receiver 400 may have the switch S4 that is open during discharging of the capacitors 206(1) and 206(2) and closed during charging of the capacitors 206(1) and 206(2). The second pin of the capacitor 206(2) is coupled with the first pin of the capacitor 206(1) through a switch S2.

In an embodiment, the electric switch arrangement 402 may couple the at least two capacitors 206(1), 206(2) in series immediately for the discharge.

In an embodiment, the electric switch arrangement 402 may couple the at least two capacitors 206(1), 206(2) in series after a delay from a beginning of said discharging for increasing efficiency of said discharge from the at least two capacitors 206(1), 206(2) to the operation of the electromechanical lock. Namely, the change from the parallel coupling to the series coupling causes the voltages of the capacitors 206(1), 206(2) to sum up and the voltage over the series coupling of the capacitors 206(1), 206(2) becomes higher than that of the parallel coupling. The operation of the data processing unit 204 and/or other electric operation can continue longer in this manner than without the change of the coupling. Alternatively or additionally, the capacitors 206 need to store less electric energy, or still alternatively or additionally, the capacities and/or sizes of the capacitors 206 may be smaller. That less electric energy needs to be stored leads to a better user experience which can be observed as shorter charging time for the lock. That in turn leads to faster operation of the lock. Additionally or alternatively, a smaller antenna and/or generator may be enable the operation of the lock.

In an embodiment, the electric switch arrangement 402 may be configured to reset automatically back to parallel coupling of the capacitors 206(1), 206(2) posterior to said discharge for the next charging. In an embodiment, the capacitors 206(1), 206(2) may remain in series coupling and the capacitors 206(1), 206(2) may be reset to the parallel coupling in conjunction with the next charging.

In an embodiment, the electric switch arrangement 402 may be reset back to parallel coupling of the capacitors 206(1), 206(2) posterior to said discharge for the next charging by control of the data processing unit 204.

In an embodiment, the electric switch arrangement 402 may remain in the series coupling after the discharge of the capacitors 206, 206(1) and 206(2). The data processing unit 204 may in conjunction of a next charging or discharging phase control the electric switch arrangement 402, by sending a control signal to the electric switch arrangement 402, to reset the switch arrangement 402 to the parallel coupling. By starting the charging phase in the series coupling it may be possible to make voltage of the series coupled capacitors to go up quicker which enables the data processing unit to start processing sooner leading to quicker opening of the lock. Still at some moment the coupling of the capacitors 206, 206(1), 206(2) may be swapped in one or more times for charging and consuming electric energy efficiently for operation of the lock.

The switches S1, S2 and S3 and potentially also S4 may be realized as relays, field effect transistors (FET) and/or diode-FET switches that may without control be in the states for charging the capacitors 206 as shown in FIG. 4A after discharging.

For charging the capacitors 206(1) and 206(2), the switches S1 and S3 are closed and the switch S2 is open, which makes the capacitors 206(1) and 206(2) be in parallel coupling as illustrated in FIG. 4A. For discharging, the switches S1 and S3 are open and the switch S2 is closed which makes the capacitors 206(1) and 206(2) be in series coupling as illustrated in FIG. 4B.

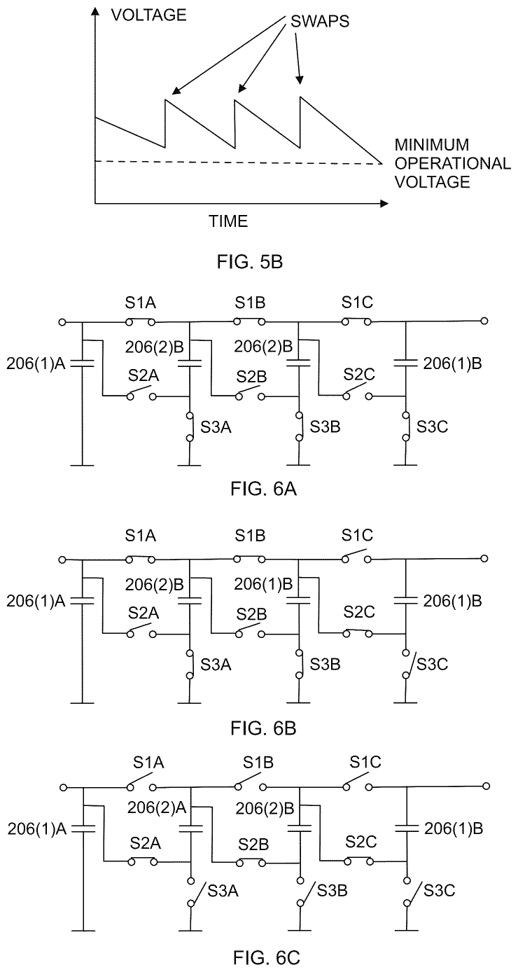

FIG. 5A illustrates an example of a voltage curve of the capacitors 206 when the coupling of capacitors 206 is changed by one swap from a parallel coupling to a series coupling. Both the axis of time and voltage are in an arbitrary scale. The voltage value that is decaying and approaching the minimum operational voltage level of the data processing unit 204 quickly increases because of the coupling swap.

In an embodiment, the electric energy receiver 400 may comprise the antenna 350 that receives electric energy of electromagnetic radio frequency radiation and feeds said electric energy through the electric switch arrangement 402 the at least two capacitors 206. The energy of the electromagnetic radiation may come from the communication device 200.

In an embodiment, the electric energy receiver 400 may comprise the electric generator 104 that may receive kinetic energy from movement of a key 112, knob or handle 130 of a barrier structure 152, convert the kinetic energy into electric energy and feed said electric energy through the switch arrangement 402 to the at least two capacitors 206.

In an embodiment, an example of which is illustrated in FIGS. 4A and 4B, the electromechanical lock comprises a sensor 404. The sensor 404 may detect voltage over the at least two capacitors 206, and feed data on said voltage to the data processing unit for monitoring and/or control of the switch arrangement 402. The control may relate to timing of or possibility to changing the coupling of the at least one of the at least two capacitors 206. The measurement of the voltage may be performed by an ADC (Analog-digital converter) of the data processing unit 204 or with a comparator that may be programmable/adjustable.

In an embodiment, the data processing unit 204 may control the electric switch arrangement 402 to swap between the parallel coupling and the series coupling of the at least two capacitors 206 in response to the voltage over the at least two capacitors 206. When the voltage has dropped the parallel coupling of the capacitors 206 may be changed to the series coupling at least partially.

In an embodiment, the data processing unit 204 may control the electric switch arrangement 402 to change the parallel coupling of the at least two capacitors 206 to the series coupling in response to crossing of a threshold of voltage over the at least two capacitors 206 in conjunction with the discharging. In an embodiment, the threshold may be about 70% of the level at the moment of beginning of the discharge, for example. In an embodiment, the threshold may be about 50% of the level at the moment of beginning of the discharge, for example. In an embodiment, the threshold may be about 30% of the level at the moment of beginning of the discharge, for example.

In an embodiment, the data processing unit 204 may monitor voltage over the at least two capacitors 206 as a function of time and detect failure if the monitored voltage and/or the trend of the monitored voltage differs from that expected. The failure may then be an operation failure of the charging electronics or the electronics that get charged.

In an embodiment, at least two of the at least two capacitors 206 may be of different charging capabilities. If the capacitors 206 have different capacitances, the coupling may be swapped after a different delay from the beginning of the discharge than in the case the capacitors 206(1) and 206(2) have equal capacitances. If the capacitors 206 have different capacitances, the coupling may be swapped after a shorter delay than in the case the capacitors 206(1) and 206(2) have equal capacitances.

In an embodiment, the capacitors 206 may be changed from the parallel coupling to the series coupling gradually. If there are N capacitors, where N is a positive integer larger than 2, P capacitors, where P is a smaller positive integer than N, may be first coupled in series with N-P capacitors. That may be performed after a first delay from the beginning of discharging. Next after a second delay, R capacitors, where R is a positive integer smaller than or equal to N-P, may be coupled in series with P capacitors. That kind of coupling sequence may continue until a suitable or desirable number of capacitors have a series coupling. The suitable/desirable number of capacitors may include all the capacitors or a portion of all capacitors. In that manner, the decay of the voltage level may be controlled in steps such that the electrical operation of the electromechanical lock has the operational voltage within a determined range for a determined period as illustrated in FIG. 5B.

FIG. 6A illustrates an example of a plurality of capacitors 206(1)A, 206(1)B, 206(2)A, 206(2)B in parallel coupling for charging. The coupling of capacitors 206(1)A, 206(1)B, 206(2)A, 206(2)B is performed by switches S1A (closed), S1B (closed), S1C (closed), S2A (open), S2B (open), S2C (open), S3A (closed), S3B (closed) and S3C (closed).

FIG. 6B illustrates an example of a plurality of capacitors coupled such that a parallel coupling of capacitors 206(1)A, 206(2)A, 206(2)B is in series with one capacitor 206(1)B for in a discharging phase. This kind of coupling may be used right from the beginning of the discharging phase, or if the discharging phase has been started with the parallel coupling, the next coupling of the capacitors may be this. After this, a next capacitor may be added to the series coupling of the capacitors 206.

FIG. 6C illustrates an example of a plurality of capacitors coupled in series. This coupling may be the last coupling stage of the sequence of various couplings of the capacitors at the discharging phase. The couplings illustrated in FIGS. 6A to 6C give guidance how to achieve the voltage behaviour of FIG. 5B. The timing of the swap(s) and/or the coupling sequence may be modified because a computer program stored in the data processing unit 204 may be updated.

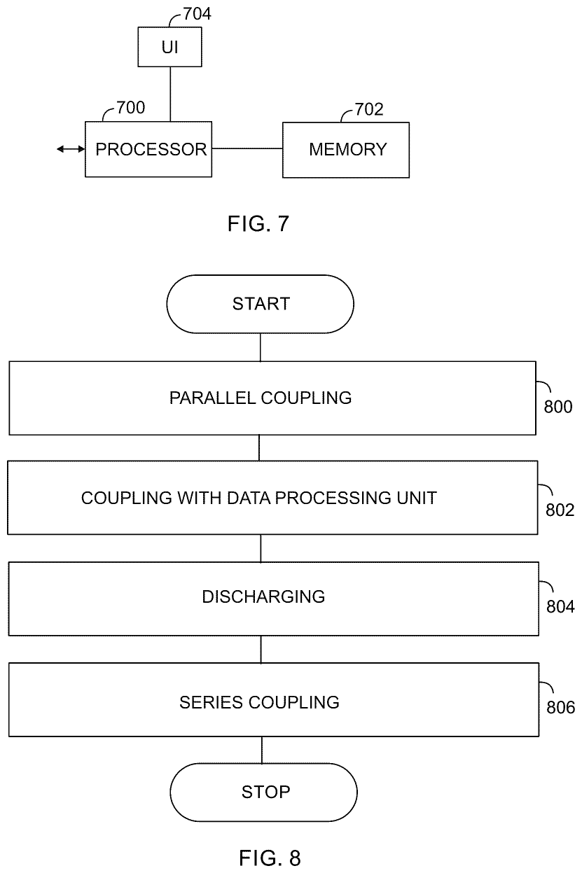

In an embodiment an example of which is illustrated in FIG. 7, the data processing unit 204 comprises one or more processors 700, one or more memories 702 including computer program code. The one or more memories 702 and the computer program code may cause, with the one or more processors 700, data processing unit 204 at least to control the electric switch arrangement 402.

The term “computer” includes a computational device that performs logical and arithmetic operations. For example, a “computer” may comprise an electronic computational device, such as an integrated circuit, a microprocessor, a mobile computing device, a laptop computer, a tablet computer, a personal computer, or a mainframe computer. A “computer” may comprise a central processing unit, an ALU (arithmetic logic unit), a memory unit, and a control unit that controls actions of other components of the computer so that steps of a computer program are executed in a desired sequence. A “computer” may also include at least one peripheral unit that may include an auxiliary memory (such as a disk drive or flash memory), and/or may include data processing circuitry.

A user interface 704 means an input/output device and/or unit. Non-limiting examples of a user interface include a touch screen, other electronic display screen, keyboard, mouse, microphone, handheld electronic game controller, digital stylus, display screen, speaker, and/or projector for projecting a visual display.

FIG. 8 is a flow chart of a method of powering an electromechanical lock. The operational electrical power is delivered through capacitors 206 that are repeatedly chargeable and dischargeable. The following steps are performed for enabling repeated charging and discharging of at least two capacitors 206.

In step 800, the at least two capacitors 206, 206(1), 206(2) are coupled in parallel by the electric switch arrangement 402 for charging the at least two capacitors (206, 206(1), 206(2)) with electric energy of the electric energy receiver 400.

In step 802, the at least two capacitors 206, 206(1), 206(2) charged with electric energy are coupled with the data processing unit 204 by the electric switch arrangement 402.

In step 804 electric energy of the at least two capacitors 206, 206(1), 206(2) is discharged for electric operation of the electromechanical lock.

In step 806, the at least two capacitors 206, 206(1), 206(2) are coupled in series by the electric switch arrangement 402 in conjunction with said discharging.

The method shown in FIG. 8 may be implemented as a logic circuit solution or computer program. The computer program may be placed on a computer program distribution means for the distribution thereof. The computer program distribution means is readable by a data processing device, and it encodes the computer program commands, carries out the measurements and optionally controls the processes on the basis of the measurements.

The computer program may be distributed using a distribution medium which may be any medium readable by the controller. The medium may be a program storage medium, a memory, a software distribution package, or a compressed software package. In some cases, the distribution may be performed using at least one of the following: a near field communication signal, a short distance signal, and a telecommunications signal.

It will be obvious to a person skilled in the art that, as technology advances, the inventive concept can be implemented in various ways. The invention and its embodiments are not limited to the example embodiments described above but may vary within the scope of the claims.

1. An electromechanical lock, wherein the electromechanical lock comprises a data processing unit, at least two capacitors, an electric switch arrangement and an electric energy receiver;
the electric switch arrangement is, for enabling repeated charging and discharging of the at least two capacitors, configured to
couple the at least two capacitors in parallel for charging the at least two capacitors with electric energy of the electric energy receiver,
couple the at least two capacitors charged with electric energy with the data processing unit, the at least two capacitors being configured to discharge electric energy for electric operation of the electromechanical lock,
couple the at least two capacitors in series for said discharging.

2. The electromechanical lock of claim 1, wherein the electric switch arrangement is configured to couple the at least two capacitors in series after a delay from a beginning of said discharging for providing the electromechanical lock with electric energy.

3. An electromechanical lock of claim 2, wherein the delay after which the electric switch arrangement is configured to couple the at least two capacitors in series is programmably set or it may be based on a measurement of voltage over the capacitors.

4. The electromechanical lock of claim 1, wherein the electric energy receiver comprises an antenna configured to receive electric energy of electromagnetic radio frequency radiation and feed said electric energy toward the at least two capacitors.

5. The electromechanical lock of claim 1, wherein the electric energy receiver comprises an electric generator configured to receive kinetic energy from movement of a key, knob or handle of a barrier structure convert said kinetic energy into electric energy and feed said electric energy toward the at least two capacitors.

6. The electromechanical lock of claim 1, wherein the electromechanical lock comprises a sensor; and
the sensor is configured to detect voltage over the at least two capacitors; and
feed data on said voltage to the data processing unit for monitoring and/or control.

7. The electromechanical lock of claim 1, wherein the data processing unit is configured to control the electric switch arrangement to swap between the parallel connection and the series connection of the at least two capacitors in response to voltage over the at least two capacitors.

8. The electromechanical lock of claim 1, wherein the data processing unit is configured to control the electric switch arrangement to change the parallel coupling of the at least two capacitors to the series coupling in response to crossing of a threshold of voltage over the at least two capacitors in conjunction with the discharging.

9. The electromechanical lock of claim 1, wherein the data processing unit is configured to monitor voltage over the at least two capacitors as a function of time and detect failure if the monitored voltage and/or a trend of the monitored voltage differs from that expected.

10. The electromechanical lock of claim 1, wherein at least two of the at least two capacitors are of different charging capabilities.

11. An electromechanical lock of claim 1, wherein the data processing unit comprises one or more processors, one or more memories including computer program code; and
the one or more memories and the computer program code configured to, with the one or more processors, cause data processing unit at least to control the electric switch arrangement.

12. An electromechanical lock of claim 1, wherein the electromechanical lock comprises N capacitors, where N is a positive integer larger than two; the switching arrangement is configured to couple P capacitors, where P is a smaller positive integer than N, in series with N-P capacitors posterior to the first delay; and posterior to a second delay, the switching arrangement is configured to couple R capacitors in series with P capacitors, where R is a positive integer smaller than or equal to N-P.

13. An electromechanical lock of claim 1, wherein the electric switch arrangement is configured to couple the at least two capacitors in an operational connection with the electric energy receiver for charging the at least two capacitors.

14. An electromechanical lock of claim 1, wherein the electric switch arrangement is configured to reset back to parallel coupling for next charging.

15. A method of powering an electromechanical lock, the method comprising performing the following for enabling repeated charging and discharging of at least two capacitors:
coupling, by the electric switch arrangement, the at least two capacitors in parallel for charging the at least two capacitors with electric energy of the electric energy receiver;
coupling, by the electric switch arrangement, the at least two capacitors charged with electric energy with the data processing unit;
discharging electric energy of the at least two capacitors for electric operation of the electromechanical lock;
coupling, by the electric switch arrangement, the at least two capacitors in series in conjunction with said discharging.
